(19) United States
(12) Patent Application Publication
(10) Pub. No.: US 2024/0087272 A1
(43) Pub. Date: Mar. 14, 2024

(54) DYNAMIC IN-GAME APPEARANCE SELECTION BASED UPON ENVIRONMENT OR ACTIVITY

(71) Applicant: Build a Rocket Boy Games Ltd., Edinburgh (GB)

(72) Inventor: Leslie Peter Benzies, Edinburgh (GB)

(21) Appl. No.: 18/464,925

(22) Filed: Sep. 11, 2023

Related U.S. Application Data
(60) Provisional application No. 63/405,699, filed on Sep. 12, 2022.

(51) Int. Cl. G06T 19/20; A63F 13/52

(52) U.S. Cl. CPC G06T 19/20; A63F 13/52; A63F 13/533; G06T 2219/2004; G06T 2219/2024

(57) ABSTRACT

Systems, methods, and machine-readable media for avatar customization within a three-dimensional virtual environment. The method includes generating the three-dimensional virtual environment including an avatar representing a user within the three-dimensional virtual environment, the avatar having an original avatar appearance, detecting a transition signal within the three-dimensional virtual environment for the avatar, searching an appearance database for an alternative avatar appearance associated with the transition signal, detecting the alternative avatar appearance associated with the transition signal, and updating the avatar to incorporate the alternative avatar appearance to thereby cause the alternative avatar appearance to be present within the three-dimensional virtual environment in association with the avatar.

### RELATED APPLICATION INFORMATION

This patent claims priority from U.S. provisional patent application No. 63/405,699 entitled “DYNAMIC IN-GAME OUTFIT SELECTION BASED UPON ENVIRONMENT OR ACTIVITY” filed Sep. 12, 2022, the entire content of which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to interactive three-dimensional computer-generated environments and, more particularly, to dynamic alteration of virtual avatar appearance in response to environment or activity changes.

### Description of the Related Art

In the traditional internet context, a user may launch a chat application, such as Instant Messenger or Slack, to chat with other users. Alternatively, the user may engage in web browsing using software like Internet Explorer or Chrome. Further, the user may play a video game alone or may sign on to an online game to play a teams versus teams style game or a massively multiplayer online (MMO) game. Historically, such games were played using a two-dimensional displayed image which may represent a three-dimensional virtual environment. In this patent, the term “environment” means the virtual space in which a game or other activity occurs. With the current availability of consumer virtual reality headsets, many games are now played with a three-dimensional display of the three-dimensional virtual environment.

The metaverse is a somewhat vague set of concepts related to software and technology that is viewed as the next generation of the Internet. In this patent, the “metaverse” is specifically defined as an online environment to which users may enter (i.e. connect to) to engage in various and varied activities. The metaverse is, or will be, implemented as an immersive space, preferably a three-dimensional space, into which a user can enter. A user within the metaverse is commonly represented by a three-dimensional character, commonly called an “avatar”. Avatars indicate the position and activity of respective users. Once within the metaverse, a user theoretically could access all desired game types, content types, and engage in any community or solo activity that the user desires. In over-simplified terms, the metaverse may be a three-dimensional virtual environment that encompasses the three-dimensional virtual environments of many individual games. The metaverse is traditionally understood to be continuously evolving with new content and interactions and users being added. Ideally, a single metaverse will encompass all online activities, Alternatively, there may be multiple metaverses which may be, for example, hosted by different entities.

The background of metaverse technology is effectively video game massively multiplayer online technology. However, the broader scope of use, new use cases, and the varied game or experience types within the metaverse all introduce a number of problems that must be addressed by any prospective metaverse creator.

For example, in a traditional game context, players may often alter the appearance of their avatar. For example, many RPG (role-playing games) and RPG-like games begin in their very early stages with a “character creator” system. Therein, a player may select a gender, a hair style, a skin color, a build type, a height, a weight, and in some cases alter, move or shape the overall appearance of their player avatar in numerous ways. Sometimes players try very hard to make their avatar appear just as they do in reality. Other players purposefully choose an avatar with an appearance starkly different from their own. Still other players make intentionally ugly, or beautiful, or strange avatars. And still other players attempt to make their avatars look like famous individuals or particular movie characters or characters from other games.

Thereafter, many of these games incorporate a “clothing” system or “armor” system. As the player proceeds through the game, different in-game clothing may be acquired from dungeons, purchases, awards, rewards, as a result of quest completion, or in various other ways. This clothing may be functional—e.g. adding in-game “armor” points or hit points or other magical or special abilities to an avatar—or may be purely aesthetic—altering player appearance only. A player may have a player avatar wear a given piece of clothing or armor because it is the “best” for that character or a given situation, or a player may have a player avatar wear the clothing because they like the way it looks on their avatar.

Over time, numerous in-game items may be acquired, all of which may be worn on the player avatar. These items may alter the appearance of the avatar by being flamboyant armor or weapons, or may simply be a white t-shirt, a red t-shirt, a blue t-shirt, etc. Tuxedos may be acquired, fancy boots, sunglasses of different shapes and types, and unusual hats. Virtually any type of clothing that one could acquire in the real-world, one may acquire an equip on a player avatar in-game. A given outfit may be made up of numerous individual components that may or may not be designed to match. They can include shoes, spaulders, gloves, hats, robes, pants, belts, glasses, shirts, socks, sweaters, sweatshirts, armor components like arm guards, and shin guards, and cuirasses, moon helmets, and virtually anything else.

In other cases, “items” such as hair styles, skin colors, facial shapes, glowing effects, “mist” style effects, transparent or translucent effects, eye colors, hair colors, body shapes, “curses” (e.g. a curse that causes eyes to glow a certain color or hair to be lighted, certain vehicles, mounts (for riding) and accessories (e.g. a riding crop, or a cowboy hat for riding or a certain parachute or hang glider when falling or flying, etc.) may be acquired by a user. So, in some cases, the “items” discussed above, may not be items at all, but may merely be variations on a player avatar appearance. Still, these may be considered alternative appearances for the avatar, which may or may not be dependent upon an in-game “item” per say, but may be purchased, acquired through skill or effort, may be available to every player or to a specific subset of players, or may be otherwise available or obtained by a player.

Players tend to become particularly enamored or fascinated by their player avatars. Players often enjoy “dressing up” their characters. World of Warcraft® made by Activision Blizzard Inc. implemented a system whereby players could have multiple “outfits” easily equipable at the touch of a button. A player could save one of two complete outfits to be swapped out at a moment's notice, thereby altering the player avatar's in-game appearance. This system was beneficial, primarily for functional purposes, to enable players to quickly move between functional in-game armor sets. However, this system still required user intervention to activate. And, it only operated in World of Warcraft® which, though it was an MMO game, was still only a single game type and single game world.

With the introduction of the concept of the metaverse, particularly one in which player avatars can in one minute be sitting outside a coffee shop talking with friends, in another may be dancing in a club, in another may be driving a formula one race car or monster truck in a race, and in another moment may be engaged in a first person shooter game against other human players; the player desire for more than one associated outfit or appearance grows in connection with that player avatar's current activity or environment.

Still further, in some contexts (e.g. RPG and RPG-like games) particular items may be incredibly functionally beneficial to the gameplay, while they may look unusual or out of place while lounging at a coffee shop. For example, a giant set of spaulders for a barbarian-style fighter in an RPG game may make that barbarian stronger, or faster, or be able to take more damage before dying in-game. Those spaulders may look as out of place as flip flops in a metaverse dance club. A user may wish for their player avatar to have a more refined or pleasing appearance in such an in-metaverse location or while simply hanging out in a virtual “home” with their friends or alone.

### DESCRIPTION OF THE DRAWINGS

FIG. 1 is an overview of a system for accessing a three-dimensional virtual environment.

FIG. 2 is a block diagram of an exemplary computing device.

FIG. 3 is a functional block diagram of a system for accessing the three-dimensional virtual environment.

FIG. 4 is an example user interface for designation of an appearance for an avatar within a three-dimensional virtual environment.

FIG. 5 is an example user interface for designation of an appearance for an avatar within a three-dimensional virtual environment showing the setting of an appearance.

FIG. 6 is an example user interface for designation of an appearance for an avatar within a three-dimensional virtual environment showing an automatic selection of an appearance.

FIG. 7 is an example user interface for designation of an appearance for an avatar within a three-dimensional virtual environment showing another automatic selection of an appearance.

FIG. 8 is a flowchart of a process of automatic selection of an appearance of an avatar within a three-dimensional virtual environment.

FIG. 9 is a flowchart of a process of selection of an appearance of an avatar within a three-dimensional virtual environment for later automatic selection.

FIG. 10 is an example user interface for symmetric or asymmetric body and facial design.

FIG. 11 is a flowchart of a process of symmetric or asymmetric body and facial design.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

Herein, the present system may enable the player to set, and the metaverse to implement one or more desired contextual outfits or appearances for use within the metaverse. As a user lounges in the main lobby area or in any general purpose area (e.g. one where other players cannot fight the player against an opponent), a particular outfit may be designated by the player, and the software itself may detect the player avatar's in-metaverse location and automatically cause the player's in-game avatar to don the desired “daily life” outfit. The context may be a location within the three-dimensional world that is the metaverse (e.g. in an area known based upon the location within the world that is a pool, a player is put into a swimsuit attire) or may be based upon the type of context or activity (e.g. an avatar is running, the avatar dons a running outfit).

The metaverse enables that player avatar to remarkably easily enter or transition into a different context, location, game mode or experience mode, such as wherein the player avatar may be virtually instantly transported to a first-person shooter (FPS) game. When the software detects that transition happening, the player avatar may automatically don a more appropriate attire for such a different context, such as the FPS contest. The player may have designed camouflage for use in that game or in FPS games more generally or may have a particular flashy outfit selected for FPS games. That outfit may automatically equip when the player avatar transitions to such a different context, game mode or location. An entire outfit may transition, including all of the various components, which may or may not match.

Then, the metaverse may cause a player avatar to immediately don a tuxedo or other flashy or fancy outfit when that player avatar transitions to another context, such as an in-metaverse club, or bar, or other location where socialization is the desired result. Any number of specific (individual places or locations) or general (all social areas vs. all game areas) may be defined with particular outfits individually or collectively.

The user may set these outfits or appearances in a user interface, perhaps while in a given location, the first time the user enters that location or is preparing to enter that location or context (e.g. at a loading screen). Then, the user may “save” those desired outfits. A user may shop within or without the metaverse for new clothing or may obtain it by playing a game or taking part in another in-metaverse experience. Thereafter, the clothing set will be the default in the given location.

Much the same interactivity may be provided with respect to in-metaverse context and/or location transportation such as cars, boats, planes, helicopters, bicycles, motorcycles, etc. The player may set a desired mode of in-game transportation and given the type of location in which the player is found, that transportation may automatically be loaded. Or, the transportation may be keyed off of or a part of an appearance in much the way a shoe or shirt is, precisely because it is a part (or added to) the player's in-metaverse avatar while the player is playing. It is a part of the player avatar's appearance.

In this way, the player experience is improved by allowing the player to easily and quickly transition between in-metaverse contexts, locations and game modes, appropriately or desirably attired, without having to stop each time to alter their appearance to match the given environment. The player avatar is always ready for the given circumstance or environment and the player can simply begin to play, to interact, or to otherwise engage. Each transition may create, cause or have an associated transition signal.

This process may be facilitated by an in-game menu system that enables the user to define attire or appearance for individual games or experiences within the metaverse or may preferably enable the player to define appearance on the basis of several broad categories of general game modes. Relaxed settings, competitive game settings, and social settings may be examples of groups of experiences within the metaverse for which the player may define outfits. Then, the game will make a determination which of those in-metaverse modes the player avatar is in and will automatically alter the attire of the player avatar as directed by the player's settings.

Preference will be given to the word “appearance” herein. As used herein the word “appearance” means the overall visual and functional look of a player avatar or player craft/vehicle. Appearance expressly includes any skin color, hair color, eye color, outfit, clothing, shoes, items, weapon, and potentially craft or vehicle used, worn or shown on or with the player character as well as any craft or vehicle's paint, color, components, and function. Appearance also includes the overall shape of a body of a character (e.g. large arms, large legs, large head, small fingers, etc.) or a craft/vehicle.

The word “appearance” expressly includes the functional elements associated with a given player avatar when clothed or otherwise presented visually in a certain way. So, the appearance expressly includes any functional benefit derived from the appearance such as faster rates of fire, faster reload times of weapons, stronger attacks with melee weapons, more capability to operate a craft or vehicle, more movement speed, higher health or magic points, and various other attributes that may be enhanced or reduced by a set of clothing, items, or other appearance. As used herein, the word “functional” means that the appearance alters a characteristic, statistic or other numerical aspect of the metaverse or environment in which the player avatar is present relative to that player avatar. This could include things like increasing speed, decreasing fall speed, increasing player power or control, and the like. The differentiation being that appearance can include both visual and functional aspects or may include only one or the other in some cases. So, in this sense, appearance is not merely appearance, but may alter gameplay for certain game types (e.g. role-playing games or combat games) in addition to the player avatar's appearance within the game.

Description of Apparatus

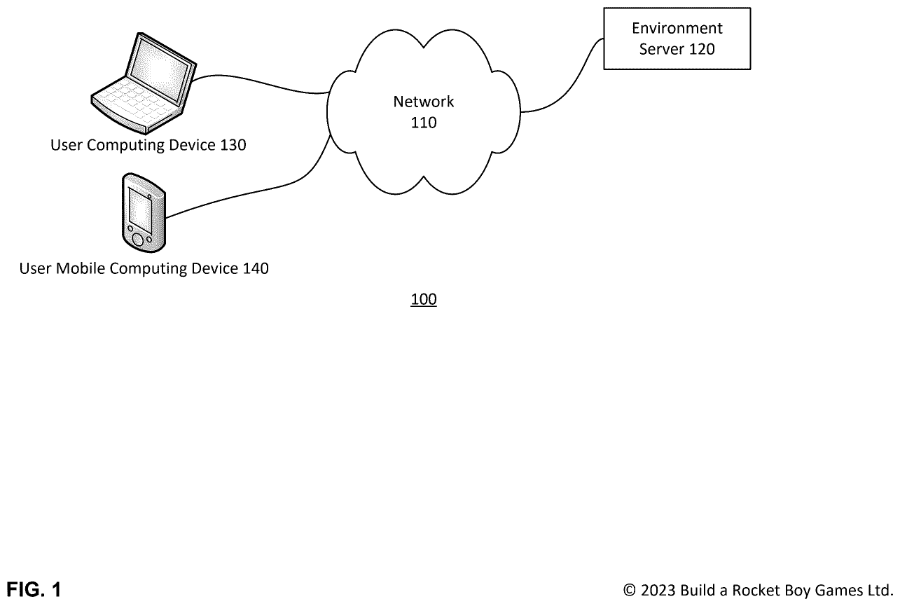

Referring now to FIG. 1, a system 100 for accessing a three-dimensional virtual environment includes an environment server 120, a content server 130, a user computing device 140, a user mobile computing device 150, and a virtual reality device 160; all interconnected by a network 110.

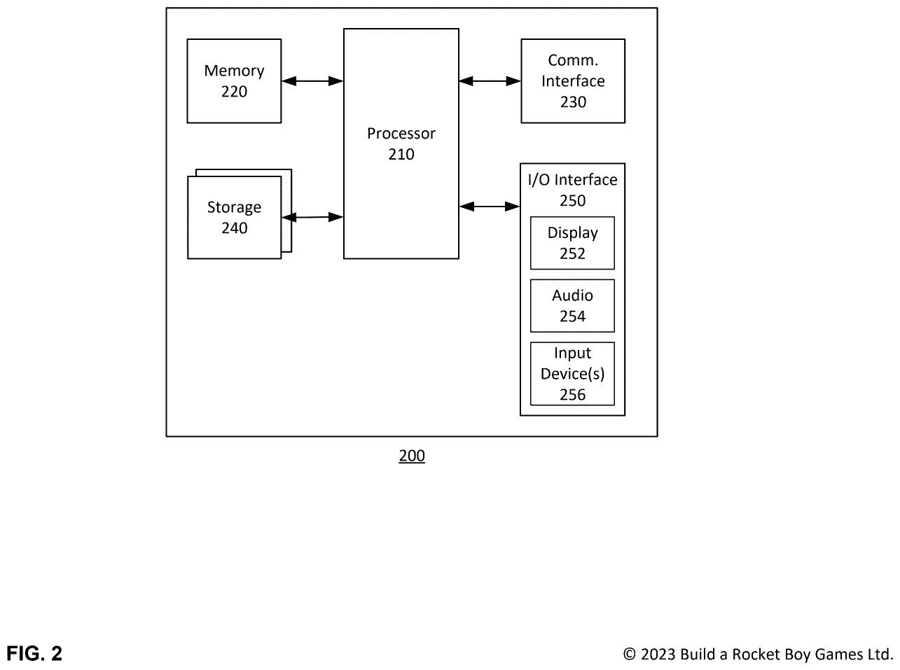

The environment server 120 is a computing device, which will be described further in conjunction with FIG. 2, or a group of computing devices. The environment server 120 is used to store three-dimensional models and any textures associated with the various three-dimensional models. These models may be player characters, environments in which the models move about, virtual automobiles, clothing, furniture, buildings, means of transport, displays, plants, and components of each of the foregoing.

The environment server 120 may operate much like a traditional “game server” to provide a server into which one or more players may log in order to move about in a virtual world comprised of the associated art assets, models and textures. The environment server may primarily operate as an orchestrator of multiple players as they connect and interact with one another, and to ensure integrity of the process of login, and uniformity of the three-dimensional virtual environment (which may actually be rendered locally on each user's machine from a set of game assets and files). The environment server 120 may merely set parameters to synchronize a group of players who are each connected to the environment server 120 through a continuous stream of control messages to each connected computing device (e.g. user computing device 130, discussed below).

The environment server 120 may be self-hosted, meaning operated by a company or entity that enables the functions and systems described herein. Alternatively, the environment server 120 may be on a shared resource service such as Amazon AWS or Microsoft Azure. Some or all of the environment server 120 may be hosted by the users of the system itself (e.g. a “chat” room made by players) so that users join their computer. In such cases, the environment server 120 or a portion thereof may actually be peer-to-peer hosted by one of the participants and merely orchestrated or controlled by a player.

The user computing device 130 is a computing device such as a personal computer, laptop computer, desktop computer or the like. The user computing device 130 may be a typical consumer computing device, lacking in any significant specialized capabilities. However, the user computing device 130 may include a GPU or an integrated GPU (e.g. integrated into a single chip with a CPU). The user computing device 130 is used by a user to connect to the environment server 120 to engage with and move an avatar about within a three-dimensional virtual environment generated by the environment server 120 (or, more accurately, on the user computing device 130 as directed by the environment server 120).

The user mobile computing device 140 is effectively identical to the user computing device, though its form factor may be that of a mobile device. It may, for example, be a mobile phone, a smart phone, a tablet computer, or other, similar device. It is shown to indicate that in some cases a user mobile computing device 140 may be used in place of the user computing device 140.

The network 110 may be or include the Internet and interconnects the various user computing device(s) 130 and the environment server 120. Other elements, not shown, may connect to any of the devices shown in the system 100.

FIG. 2 is a block diagram of an exemplary computing device 200, which may be or be a part of the environment server 120, the content server 130, the user computing device 140, the mobile computing device 150 or the virtual reality device 160 of FIG. 1. As shown in FIG. 2, the computing device 200 includes a processor 210, memory 220, a communications interface 230, along with storage 240, and an input/output interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs and routines for execution by the processor. These stored software programs may include an operating system software. The operating system may include functions to support the input/output interface 250, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals. The application can perform the functions described herein.

The communications interface 230 may include one or more wired interfaces (e.g. a universal serial bus (USB), high definition multimedia interface (HDMI)), one or more connectors for storage devices such as hard disk drives, flash drives, or proprietary storage solutions. The communications interface 230 may also include a cellular telephone network interface, a wireless local area network (LAN) interface, and/or a wireless personal area network (PAN) interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The cellular telephone network interface and/or the wireless LAN interface may be used to communicate with devices external to the computing device 200.

The communications interface 230 may include radio-frequency circuits, analog circuits, digital circuits, one or more antennas, and other hardware, firmware, and software necessary for communicating with external devices. The communications interface 230 may include one or more specialized processors to perform functions such as coding/decoding, compression/decompression, and encryption/decryption as necessary for communicating with external devices using selected communications protocols. The communications interface 230 may rely on the processor 210 to perform some or all of these function in whole or in part.

Storage 240 may be or include non-volatile memory such as hard disk drives, flash memory devices designed for long-term storage, writable media, and proprietary storage media, such as media designed for long-term storage of data. The word “storage”, as used herein, explicitly excludes propagating waveforms and transitory signals.

The input/output interface 250, may include a display 256 and one or more input devices 256 such as a touch screen, keypad, keyboard, stylus or other input devices. The input/output interface 250 may include audio 254 input/output capability. A display 252 may also interact using the input/output interface 250. The processes and apparatus may be implemented with any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run an operating system, including, for example, variations of the Linux, Microsoft Windows, Symbian, and Apple Mac operating systems.

The techniques may be implemented with machine readable storage media in a storage device included with or otherwise coupled or attached to a computing device 200. That is, the software may be stored in electronic, machine readable media. These storage media include, for example, magnetic media such as hard disks, optical media such as compact disks (CD-ROM and CD-RW) and digital versatile disks (DVD and DVD±RW), flash memory cards, and other storage media. As used herein, a storage device is a device that allows for reading and/or writing to a storage medium. Storage devices include hard disk drives, DVD drives, flash memory devices, and others.

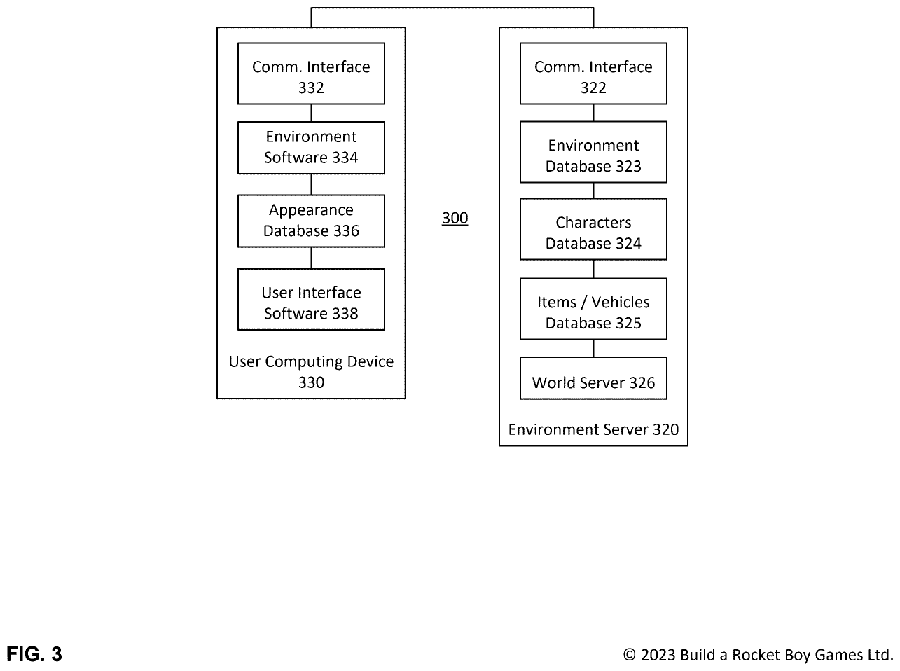

FIG. 3 is a functional block diagram of a system 300 for accessing a three-dimensional virtual environment. The system 300 includes an environment server 320 and a user computing device 330. The environment server 320 may be a version of environment server 120 and the user computing device 330 may be a version of device 130. The mobile computing device and virtual reality device are not shown because their functions are substantially the same as the user computing device 330. These are functional elements, expressed in terms of their functionally. The functional elements shown in this figure may be physically divided or organized differently than shown from a functional perspective while still conforming to the overall intended functionality and purposes. The functions shown in this figure may be implemented in hardware or software or a combination of the two.

The environment server 320 includes a communications interface 322, environment database 323, a characters database 324, an items/vehicles database 325, and a world server 326.

The communications interface 322 operates to enable communications between the interacting elements of the system 300 the user computing device 330. The communications interface 322 may include the various hardware network components discussed above as a part of the computing device 200. However, it also may include application programming interfaces (APIs), unique network connectivity systems and data protocols used by the user computing device 330 to communicate with the environment server 320 securely and efficiently under the unique circumstances of the system 300.

The environment database 323 includes all elements of the three-dimensional interactive environment of the present system 300. The environment database 323 stores the three-dimensional models used to generate the three-dimensional virtual environment. These models may be the maps of the world, the locations, the objects making up the world (e.g. cars, boats, trees, tables, chairs, clothing, etc.). The environment database 323 stores maps (of the various environments), models for aspects of those environments, such as tables, chairs, buildings, windows, non-player characters or objects, monsters and other NPCs and enemies. In operation, the environment server 320 only provides (or points user computing devices to another source to provide) actual copies of these various elements to connected devices if these elements are not already present. In a typical case, an install of the associated software will include an installation of the data files necessary for a user computing device 330 to render all of the environment while the environment server 320 passes only status update messages and similar notifications to each user computing device 330 to maintain the coordinated state of each of the connected devices, including the environment server 320. So, the environment database includes these various models, textures, animations and the like as a basis of ground-truth for what those elements are and encompass in cases in which user computing device 330 copies of such files are corrupted or otherwise unavailable for any reason.

The characters database 324 stores the models for the player avatars used within the world by all of the players. These avatars may be uniquely-designed individually by each player or may have elements drawn from groups of “components” making up the avatar bodies (e.g. sets of eyes, sets of arms, sets of legs, etc.). The character database 324 may include various textures for different skin tones of the avatars themselves, as well as different hair colors and styles, various eye colors and shapes, along with player body components or shapes for various portions of the player avatars. Some of these elements may be modifiable in-game while others may be fixed for all time while the metaverse exists. The character database 324 may also store any data related to the avatars such as items in their position, any virtual property owned by the avatar, the avatar's in-game name, any statistics or numerical representations of past successes (e.g. win rates or kill rates in competitive games) or current skills (e.g. skill in making certain items, fighting skills, skills with certain weapons, likelihood to dodge an attack, and similar skills typical to role-playing type games).

The items/vehicles database 325 stores similar information to the environment database 323, but for items that may be worn, owned, possessed, placed within the three-dimensional virtual environment, or otherwise associated with the environment or with a player avatar. These items may change the appearance of an avatar or may merely be decoration within the world. These items may be equipable, that is worn or visible on or near a player avatar, or may be placed within the three-dimensional virtual environment.

The world server 326 orchestrates the other components of the environment server 320 to enable users connected to the environment server 320 to operate to generate the three-dimensional virtual environment for user computing devices 330 connected to the environment server 320. The world server 326 may operate in much the same way as a game engine or network game server operates. Though shown as a single server, it may be many physical servers. The world server 326 enables multiple users to connect to the environment server 320 to experience the same game world or three-dimensional virtual environment simultaneously. To accomplish this, the world server 326 ensures authentication has taken place, loads the models and textures from the model database 323 and the texture database 324, and maintains a continually-updating state for the overall game including player locations and movements and animations within the three-dimensional virtual environment.

The world server 326 may simultaneously operate multiple world “types” so that users can transition from one context or location to others, for example, from racing game to fighting game to “hang out” area to a virtual combat arena, to a flying fighter aircraft area, to a racing area, to a story-based game, to a concert, to a shopping area, and so on. Each of these experiences may be hosted by the world server 326. In this way, a single or multiple servers may be employed as the world server 326. In cases with a larger server population or particular game types that are overpopulated, sharded servers may be employed to load balance the total user population in a given area or on a server. The world server 326 may dynamically allocate and deallocate physical server capacity dependent upon the current load or need either in aggregate or for particular experiences.

The user computing device 330 is a computing device used by a user to access the environment server 320. The user computing device 330 is shown as only a single device for example purposes, but a single environment server 320 can service numerous (hundreds or thousands) of simultaneous connections and interactions with user computing devices like user computing device 330. The user computing device 330 is commonly a desktop or laptop computer, but may be a mobile device or a virtual reality device or similar computing device. The user computing device 330 includes a communications interface 332, environment software 334 and user interface software 336.

The communications interface 332 is primarily used to enable interaction of a player's avatar and software with the environment server 320 and to obtain and stream content from the content server 330. The communications interface 332 may include the various hardware network components discussed above as a part of the computing device 200. However, it also may include application programming interfaces (APIs), unique network connectivity systems and data protocols used by the user computing device 330 to communicate with the environment server 320 securely and efficiently under the unique circumstances of the system 300.

The environment software 334 is software for presenting the three-dimensional virtual environment served by the environment server 320 to the user computing device 330. Traditionally, the environment software 334 would be an implementation of a “game engine” software that integrates three-dimensional models, textures for those models, scripting to enable functions and interaction within the three-dimensional virtual environment, and various other functionality taking place within the environment server 320. The environment software 334 preferably integrates the authentication functions to enable the environment software 334 to access the world server 326 to enable the functions discussed herein. In a simplified sense, user may move a three-dimensional avatar about in a three-dimensional virtual environment, interact with the environment. While engaged with the world server 326, the user may transition the player avatar to a new context, location or three-dimensional virtual environment using any number of metaphors, such as doorways, portals, “fast-travel,” vehicular travel, and other similar techniques.

The appearance database 336 is shown as a part of the user computing device 330, but it may be in whole or in part present on the environment server 320 instead. This may aid in portability (e.g. a user logs into the world server 326 from a different location. The appearance database 336 stores the various appearances for each player avatar (there may be more than one) and the associated transition signal.

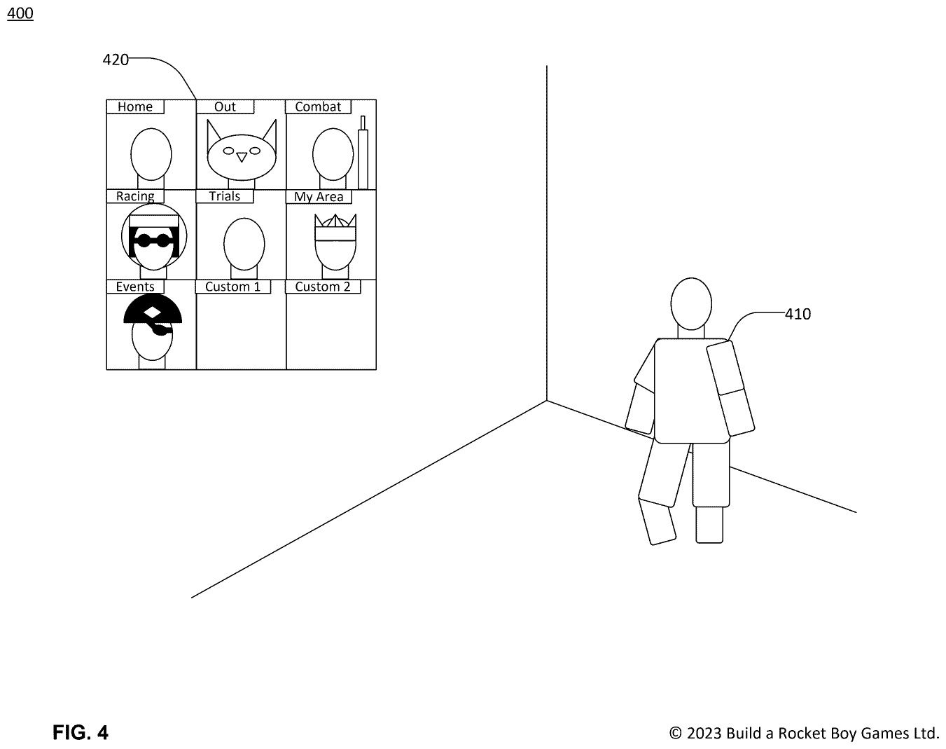

The phrase “transition signal” as used herein means a trigger or signal that is created by, caused by and/or indicates that a player avatar has changed from one three-dimensional virtual environment to another, to a different context or location within the same three-dimensional virtual environment, or has begun engaging in an activity within the same or another three-dimensional virtual environment. The transition signals may correspond to a change from one to another of the contexts and/or locations identified in FIGS. 4-7 (e.g. “home,” “out,” “combat,” “racing,” “trials,” “my area,” “events,” “custom 1,” and “custom 2.”). The contexts or locations may be hard coded (e.g. a game type or experience type may flag itself as “combat” thereby indicating when the player transitions to such an area, or is teleported to such an area or launches that style game that that context trigger is triggered as a transition signal. These may be game-wide transition signals that may be set as flags for certain locations or certain load screens and the like (e.g. entering a virtual club could trigger “out”).

In other cases, like the custom 1 and custom 2, a player may design their own context. This could be effectively in-game scripting or modification (e.g. “modding”) whereby a player must code or pseudo code their own contexts or locations. This could be in the area associated with a particular other player, that a certain outfit or appearance is equipped. This could be in the presence of a certain other player or object, a particular appearance is equipped. This could be every third Tuesday of the month, the player dyes their hair orange, thereby altering their appearance accordingly and automatically. This could be a rotating series of appearances that change one after the other over the course of an hour or two as the appearance. This could be that if, in combat, there are 10 enemy players left on the battlefield, then this appearance is equipped (e.g. a machine gun or sniper rifle), but if fewer than 2 enemy players are left on the battlefield, then an alternative appearance is equipped (e.g. a silenced pistol). The options for custom contexts which may be player set are virtually endless.

The appearance database 336 stores the entirety of the associated appearances and the transition signal for those appearances in order to enable the system to operate automatically to change player avatar appearances as the transition signal(s) occur.

The user interface software 338 operates to enable a player or user using the user computing device 330 to control the environment software, its functions, and to alter settings associated with the world server 326/environment software 334. So, simple settings may be field of view, volume of sound, brightness, contrast, and the like. Other settings may relate to locations in the three-dimensional virtual environment that the player does not wish his or her avatar to visit or settings related to operation of the game itself (e.g. how to cast spells, fight, race, or engage in text chat or voice chat).

Importantly for purposes of this disclosure, the user interface software 336 enables a user or player to select an appearance for their player avatar for use within certain contexts and locations within the metaverse or game. Some examples of a simplified version of those user interfaces appear in FIGS. 4-7 and are discussed below.

FIG. 4 is an example user interface 400 for designation of an appearance for an avatar within contexts of a three-dimensional virtual environment. Here, the player avatar 410 can be seen alongside a menu 420 for setting and for selecting an appearance associated with a particular context within the three-dimensional virtual environment. Contexts like “home,” “out,” “combat,” and the like can be seen. For example, combat shows a normal player head but with a weapon near the player avatar's head so that the player may identify the “loadout” for use in combat. Importantly for this disclosure, that weapon may or will have statistics and characteristics (usually numerical) associated with it that demonstrate its power, range, accuracy, speed of reload, and the like. The choice of a particular weapon for an appearance for the “combat” scenario has both an appearance (e.g. the player avatar is holding a weapon) and a functional (e.g. the weapon has certain statistics or characteristics) that are associated with the setting and, later, automatic selection of that appearance.

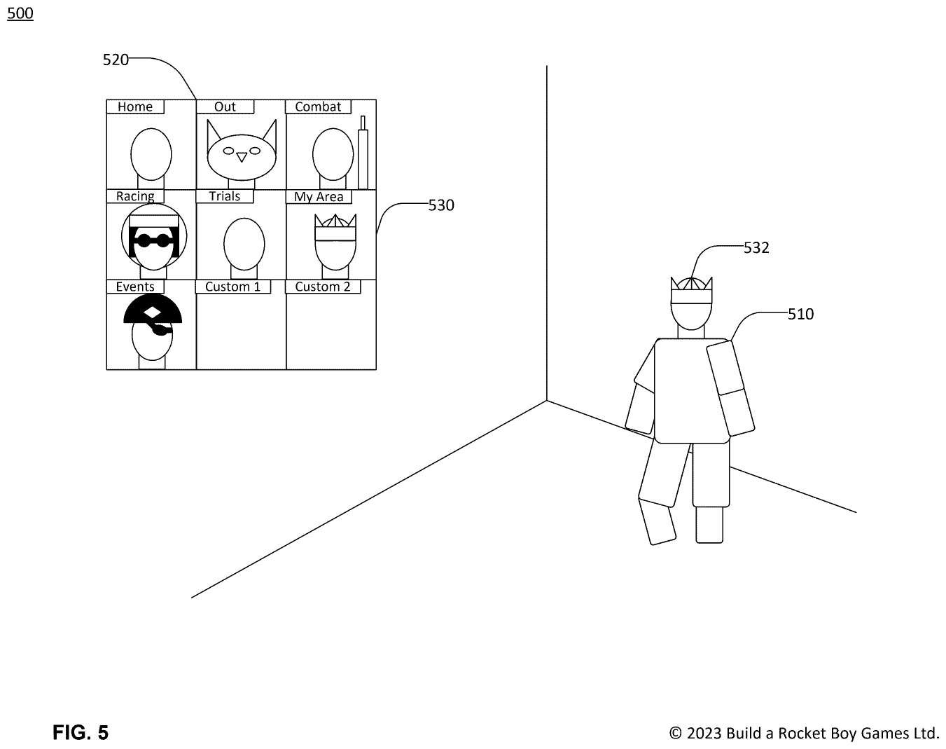

FIG. 5 is an example user interface 500 for designation of an appearance for an avatar within a context of a three-dimensional virtual environment showing the setting of an appearance. Here, the player avatar 510 is still visible, but the user has donned a crown 532 on their player avatar also visible in the menu 520. This crown 532 may merely be decorative or may have been awarded for winning a battle, may be the result of the game determining that the player avatar is helpful within the three-dimensional virtual environment, may have been purchased with in-game currency or real currency, or may be the result of being voted by other players as “king” of the three-dimensional virtual environment.

Here, the player has designated the crown 532 for use in “my area” designation at 530. To accomplish this, the player may don the desired outfit, through typical methods known in the art for altering appearance or changing outfits, and then may select the “my area” box on the user interface to “save” the appearance as the appearance that is automatically used within “my area” within the three-dimensional virtual environment. The “my area” may be a unique piece of virtual land “owned” or under the control of the player. Or, it may be a home within a virtual city block that is associated with the player avatar. The user interface 520 accepts updates to the appearance associated with each of these areas or contexts (e.g. racing is a context, not a particular location within the three-dimensional virtual environment.

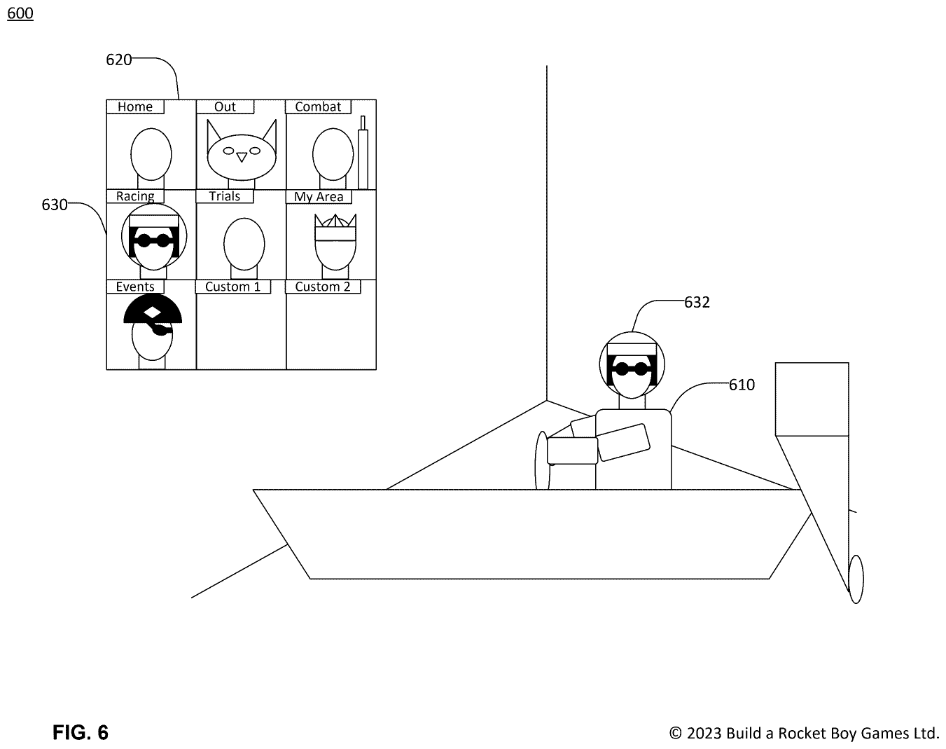

FIG. 6 is an example user interface 600 for designation of an appearance for an avatar within a three-dimensional virtual environment showing an automatic selection of an appearance. Here, the player avatar has transitioned from one context or location to another such as to a space where the avatar is engaged in a boat race (or soon will be). This transition may take place, prompting a transition signal, by moving the player avatar to a race location or by teleportation through a virtual portal within the three-dimensional virtual environment or simply sitting in a boat (or other vehicle). Here, the previously-selected appearance including a racing helmet for “racing” at 630 has been automatically set by the system because the context in which the player avatar has moved has changed (through whatever transition). The racing appearance 632 appears on the player avatar 610 automatically. The transition will cause a transition signal.

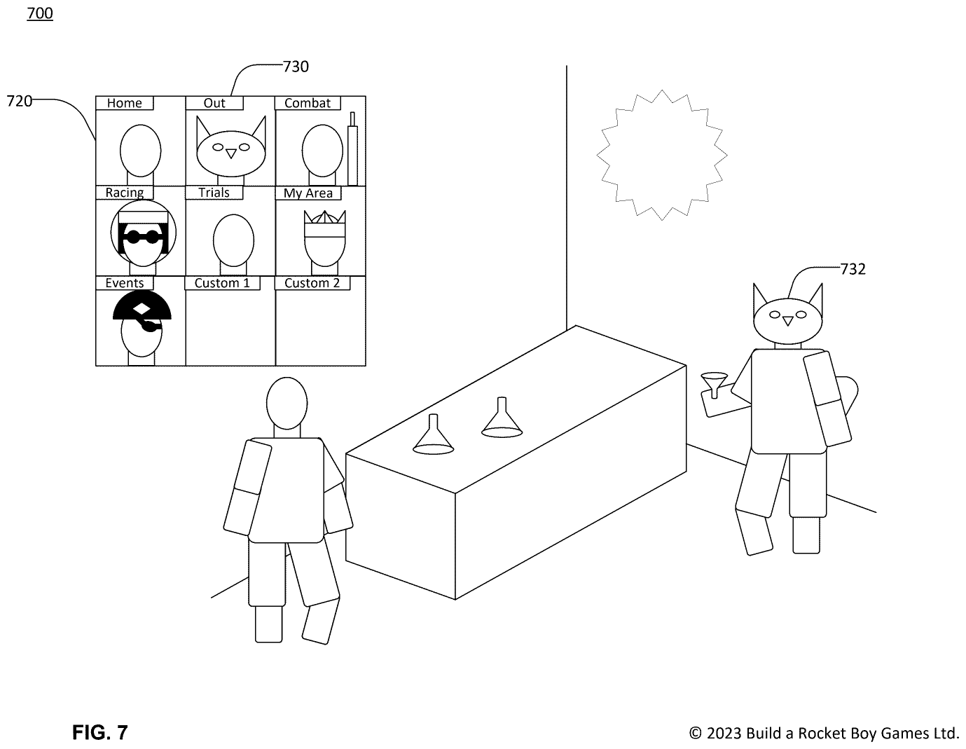

FIG. 7 is an example user interface 700 for designation of an appearance for an avatar within a three-dimensional virtual environment showing another automatic selection of an appearance. Here, the player avatar has transitioned from one context or location to another, such as when the avatar entered a club. Automatically, the out cat head 730 has been selected as shown in the menu 720. The appearance 732 of the player avatar has also changed according to the designation “out”. Here, the club may be identified as a location flagged as “out” and the transition signal may be the player walking into or teleporting to the club.

Description of Processes

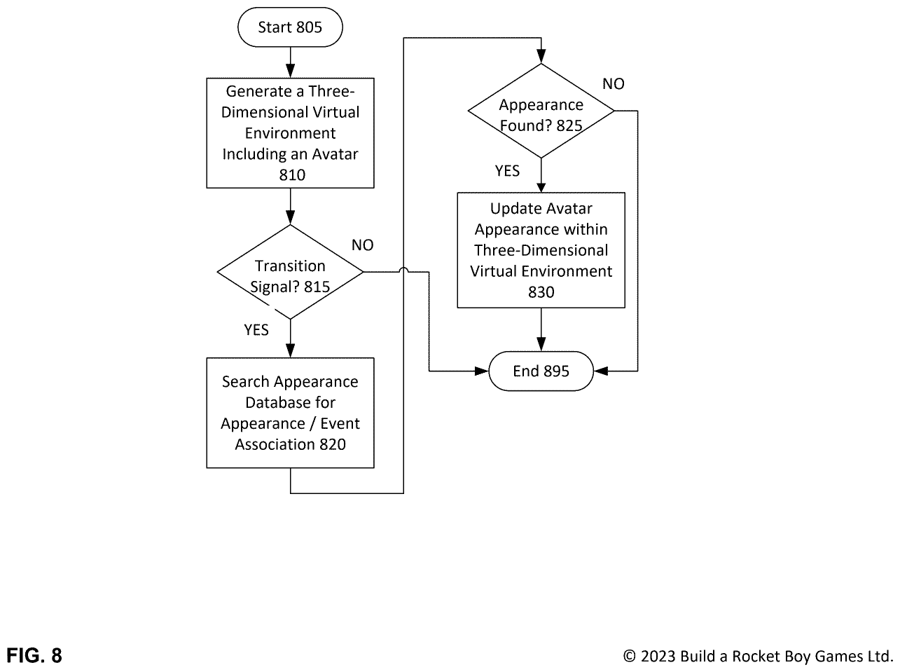

FIG. 8 is a flowchart of a process of automatic selection of an appearance of an avatar within a three-dimensional virtual environment. The process starts at 805, for example when a first users goes online, and ends at 895. The process may be repeated at will by the first user and multiple instances of the process may occur concurrently for a corresponding number of users.

Following the start 805, the process begins with the generation of a three-dimensional virtual environment including an avatar at 810. Here, the world server 326 creates a world, such as having a certain context and/or location, and the user computing device connects to that world using the environment software 334. The world is loaded and a player avatar is visible on the display of that user computing device. The avatar may be in a general area open to every player or may be in a “home” space associated with the player avatar.

Next, a determination is made whether a transition signal is detected or not. The transition signal may be caused by the avatar transitioning from a certain context and/or location to another. If not (“no” at 815), then the process ends at 895.

If a transition signal is detected (“yes” at 815), then a search of the appearance database 336 is made for an event or context association at 820. Here, the system searches for a particular avatar appearance associated with the event, location or context transitioned to in order to begin the automatic transition process.

If there is none (“no” at 825), then the process ends at 895.

If there is an appearance found (“yes” at 825), then the process continues with updating the avatar appearance within the three-dimensional virtual environment to correspond to the appearance associated with the particular transition signal at 830. The player avatar is updated and the process then ends at 895.

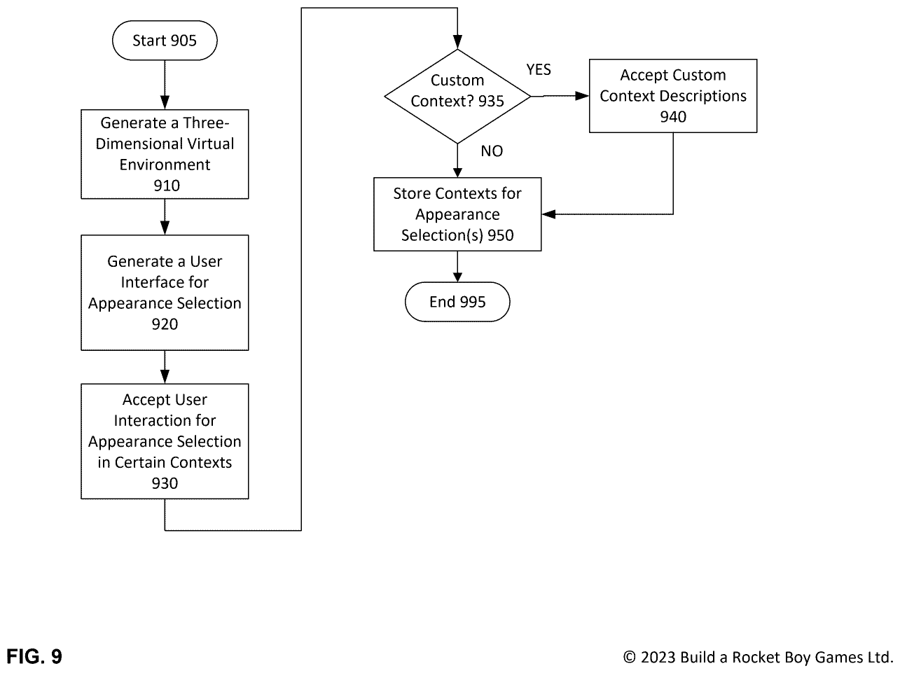

FIG. 9 is a flowchart of a process of selection of an appearance of an avatar within a three-dimensional virtual environment for later automatic selection. The process starts at 905, for example when a first users goes online, and ends at 995. The process may be repeated at will by the first user and multiple instances of the process may occur concurrently for a corresponding number of users.

Following the start at 905, the process begins with generation of a three-dimensional virtual environment at 910. Here, the world server 326 and the environment software 334 operate together to enable the user computing device to generate a three-dimensional virtual environment on the user computing device display.

Within that environment a user interface for appearance selection may be generated at 920. Here, the user interface enables players or users to equip certain items or otherwise to alter the appearance of their avatar to their liking. As indicated above, this may involve equipping or donning certain items, either or both of for appearance and for functional purposes, and otherwise fully outfitting a character in a desired appearance. This could be a whole host of many items or a single item or appearance change. The user interface enables this selection to take place at 920 and the three-dimensional virtual environment shows the altered appearance to the user via the display of the user computing device.

Next, the user interface accepts user interaction for appearance selection (e.g. equipping the items or other appearance changes) and the identification of those appearances with certain contexts or locations at 930. Here, the player avatar transition signals are created by associating the appearance selected by the player at 920 with a particular context (e.g. “racing” or “out” or “combat”). The result of using the pre-set contexts is that the appearances may be easily and automatically selected once the transition signal associated with those contexts occur.

At 935, a determination is made whether the user selected a custom context. If so (“yes” at 935), then the process moves to acceptance of the custom context descriptions. This is where a more sophisticated user may literally code or pseudo code a particular context and transition signal. Or, less-sophisticated users may be able to select from a list of available custom contexts or to use a set of user-friendly options to craft effectively an automation context for their custom transition signal. As indicated above, this could be any number of contexts (e.g. presence of a particular player, presence in a particular location or near a particular object, a particular day or time, a particular mini-game or action being taken by the player avatar or someone around the player avatar). The options are nearly-endless.

If there is no custom context (“no” at 935) or after that custom context description is received at 940, then the contexts (e.g. transition signals) for appearance selection(s) are stored at 950 within the appearance database 336. Thereafter, the process of FIG. 8 will be enabled to respond to transition signals associated with those contexts. The process of FIG. 9 may be repeated to alter or update the appearance, transition signal, or contexts for a given player avatar. And, copies of the appearance database may be stored remotely to enable this process to take place no matter from what device a player logs into the environment server 320.

The process then ends at 995.

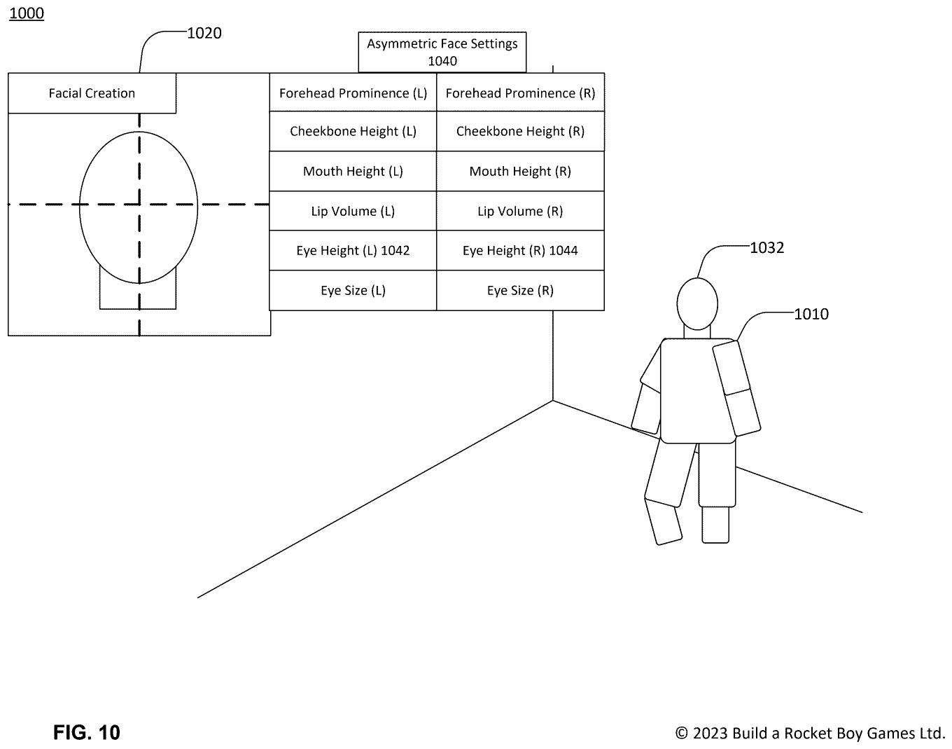

FIG. 10 is an example user interface for symmetric or asymmetric body and facial design. The user interface 1000 of FIG. 10 is simplified for purposes of discussion. As is known in the art, certain game engines incorporate sliders, or selectors, buttons, or other metaphors for alteration of a desired player avatar's appearance. This is typically accomplished during the initial stages of gameplay, particularly in role-playing games. But, in massively-online games of most types, players can feel a strong affinity for their avatar and desire that the avatar represent their actual appearance or their imagined or preferred appearance. For some players, the game world or the metaverse presents the opportunity to be more themselves or to present a public image that is different from their real-world appearance, but desirable for other reasons This alteration of the player avatar's actual appearance (e.g. face, head, body shape, sex, gender, etc.) can be incredibly personal and very important. And, this aspect of a player experience, separate from items collected, may be considered a part of the appearance described throughout this application.

What is more, some players lack symmetry in their bodies or faces as well. There are individuals with missing limbs, with birth deformities, with organs or portions of their face or body significantly different from symmetrical due to medical reasons, accidents, or sometimes intentionally done. In the past, these asymmetries have not generally been capable of representation within game worlds or three-dimensional virtual environments. Most games and similar experiences rely upon perfect symmetry. It is beneficial in that it saves memory to merely mirror a player avatar mesh and associated texture. Providing asymmetry requires more memory use and graphic processing power. Across hundreds or thousands of players which may be present within an area in massively multiplayer environments, this additional bandwidth and GPU power can compound.

In this simplified user interface 1000, the player avatar 1010 is represented within a three-dimensional virtual environment. The player avatar's head 1032 is also shown within the environment. A closeup face 1020 of the facial creation may be shown, and may include a cross-sectional indicia dividing the face (or body) into a plurality of quadrants or halves or other sub-divisions.

If a user desires, the user may select a button to enable asymmetric face settings 1040. Without this setting, the face (or body) may remain fully symmetrical, as is common in the art. Without the setting activated, the player avatar's face will be adjusted uniformly on both sides of the face (or body).

However, if the asymmetric face settings 1040 is selected, independent settings may be activated for the left and right sides of a player's face (or body). The facial features shown may merely be a subset of possibilities. There can be numerous sliders and textures and colors selectable for a given avatar Here, only seven are shown, but some examples of these types of interfaces have hundreds of settings and hundreds of options in each setting. Here, forehead prominence, cheekbone height, mouth height, lip volume, eye height, and eye size are all shown.

A user may independently adjust eye height (L) 1042 and eye height (R) 1044 for the player avatar's face. As most humans have experienced, facial features are generally not exactly uniform. And, scientific studies have indicated that slight facial non-symmetry is actually viewed as beautiful by most humans. So, adjusting these two eye height settings 1042, 1044 independently may cause the player avatar's eyes to be slightly different heights on the face 1020 of the player avatar. Even things like eyebrow color or hair color or beard/no beard could be present in an asymmetrical form. And, much as any aspect of the player avatar's appearance discussed above, the user may set transition signals associated with certain contexts that cause the player's facial or body symmetry to alter, thereby changing the player avatar's appearance for certain contexts.

The same general process is possible for faces, but also for player avatar bodies or body parts (e.g. torsos, arms, legs, etc.). In general, the player avatar's overall appearance may be entirely symmetrical, but a given user or player may desire to create an appearance that is asymmetrical in any of its aspects.

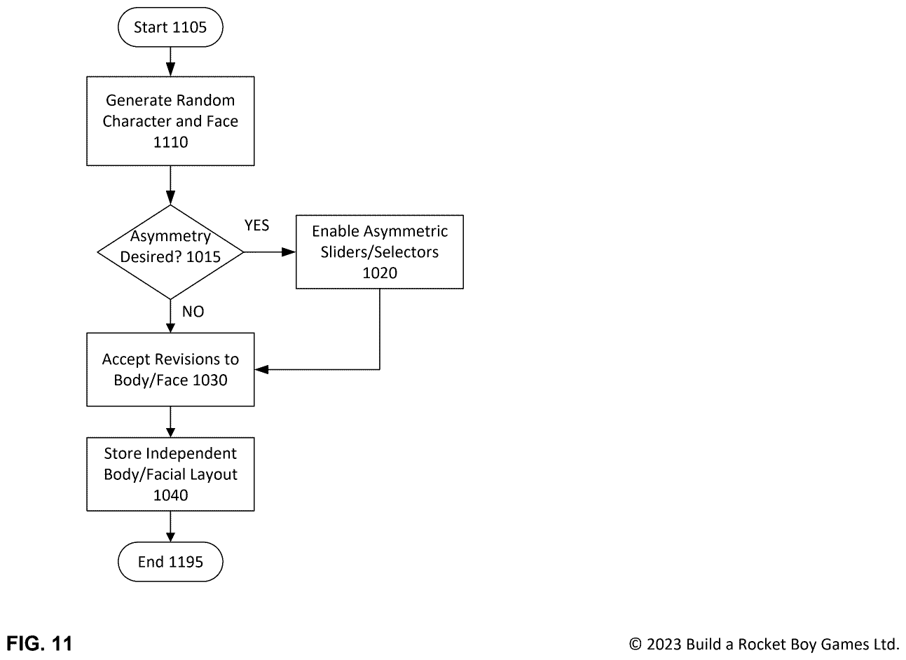

Turning to FIG. 11, a flowchart of a process of symmetric or asymmetric body and facial design is shown. The process has a start 1105 and an end 1195, but it may take place as many times as the user desires to alter the physical appearance or symmetry of their player avatar.

Following the start at 1105, the process begins at 1110 with generation of a random character and face. This is an assumption that it is the first iteration of character or avatar creation. In subsequent iterations, the existing character avatar may be loaded instead. Here, the body and face of the player avatar is created and/or loaded to be visible, much like the user interface 1000 of FIG. 10.

Next, a determination is made whether asymmetry is desired at 1015. Here, the system (usually the user computing device) checks to see whether the player or user has activated the asymmetry setting for a face or body. If so (“yes” at 1015), then the asymmetric sliders/selectors are enabled at 1020. Here, the player will now be able to move various characteristics of the player avatar's face or body independently of each other.

If not (“no” at 1015) or after the asymmetric sliders/selectors are enabled at 1020, then the system may accept revisions to the body/face of the player avatar 1030. Those may be symmetrical or asymmetrical. Many settings may be altered, thereby allowing the player to create a unique and desirable player avatar.

Thereafter, the body or facial layout is stored at 1040. Here, the symmetrical settings or asymmetrical settings are stored. The environment server 320 may obtain a copy of the player avatar's settings and textures and model upon login so that it may be provided (or its related information may be provided) to other players. Typically, that information will be stored on the user computing device 330.

The process then ends at 1195.

### Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. A system for avatar customization within a three-dimensional virtual environment comprising a computing device for:
generating the three-dimensional virtual environment including the presence of an avatar representing a user within the three-dimensional virtual environment, the avatar having an original avatar appearance;
detecting a transition signal within the three-dimensional virtual environment for the avatar;
searching an appearance database for an alternative avatar appearance associated with the transition signal;
detecting the alternative avatar appearance associated with the transition signal; and
updating the avatar to incorporate the alternative avatar appearance to thereby cause the alternative avatar appearance to be present within the three-dimensional virtual environment in association with the avatar, wherein the alternative avatar appearance is selected based upon an attribute of the three-dimensional virtual environment detected within the transition signal.

2. The system of claim 1 wherein the transition signal is triggered by a selected one of:
movement of the avatar from one location within the three-dimensional virtual environment to another location within the three-dimensional virtual environment;
movement of the player from one context within the three-dimensional virtual environment to another context within the three-dimensional virtual environment;
transition from one game mode to another game mode within the three-dimensional virtual environment;
transition from a first three-dimensional virtual environment to a second three-dimensional virtual environment;
transition from the three-dimensional virtual environment to a two-dimensional virtual environment;
initiation of a different mode of play within the three-dimensional environment selected from the group comprising first person shooter combat, a race game, a sports mode, a relaxation mode, a dance mode, a travel mode, a mode associated with the user's self-managed area within the three-dimensional virtual environment, and a lounge mode;
selection of an item or object within the three-dimensional virtual environment;
a load screen associated with transition from a first three-dimensional virtual environment and a second three-dimensional virtual environment;
initialization of the three-dimensional virtual environment in a particular location or to engage in a particular activity; and
transition into operation of a digital vehicle within the three-dimensional virtual environment.

3. The system of claim 1 wherein the computing device is further for:
receiving a selection of the alternative avatar appearance as associated with the transition signal from the user; and
storing the transition signal as associated with the alternative avatar appearance in the appearance database.

4. The system of claim 1 wherein the computing device is further for:
receiving a plurality of selections of alternative avatar appearances associated with a plurality of transition signals from the user; and
storing the plurality of transition signals as associated with the plurality of avatar appearances in the appearance database.

5. The system of claim 1 wherein the alternative appearance is associated with a functional aspect of the three-dimensional virtual world or the avatar such that alteration of the appearance causes a numerical change in an aspect of the three-dimensional virtual world or the avatar that changes gameplay or functionality of the avatar within the three-dimensional virtual world.

6. The system of claim 1 wherein:
the alternative appearance is non-functional, but alters an appearance of the avatar within the three-dimensional virtual world;
the alternative appearance is functional and alters the appearance of the avatar within the three-dimensional virtual world; and
the alternative appearance is functional, but does not alter the appearance of the avatar within the three-dimensional virtual world.

7. A method for avatar customization within a three-dimensional virtual environment using a computing device, the method comprising:
generating the three-dimensional virtual environment including an avatar representing a user within the three-dimensional virtual environment, the avatar having an original avatar appearance;
detecting a transition signal within the three-dimensional virtual environment for the avatar;
searching an appearance database for an alternative avatar appearance associated with the transition signal;
detecting the alternative avatar appearance associated with the transition signal; and
updating the avatar to incorporate the alternative avatar appearance to thereby cause the alternative avatar appearance to be present within the three-dimensional virtual environment in association with the avatar, wherein the alternative avatar appearance is selected based upon an attribute of the three-dimensional virtual environment detected within the transition signal.

8. The method of claim 7 wherein the transition signal is triggered by a selected one of:
movement of the avatar from one location with the three-dimensional virtual environment to another location within the three-dimensional virtual environment;
transition from one game mode to another game mode within the three-dimensional virtual environment;
movement of the player from one context within the three-dimensional virtual environment to another context within the three-dimensional virtual environment;
transition from a first three-dimensional virtual environment to a second three-dimensional virtual environment;
transition from the three-dimensional virtual environment to a two-dimensional virtual environment;
initiation of a different mode of play within the three-dimensional environment selected from the group comprising first person shooter combat, a race game, a sports mode, a relaxation mode, a dance mode, a travel mode, a mode associated with the user's self-managed area within the three-dimensional virtual environment, and a lounge mode;
selection of an item or object within the three-dimensional virtual environment;
a load screen associated with transition from a first three-dimensional virtual environment and a second three-dimensional virtual environment;
initialization of the three-dimensional virtual environment in a particular location or to engage in a particular activity; and
transition into operation of a digital vehicle within the three-dimensional virtual environment.

9. The method of claim 7 wherein the computing device is further for:
receiving a selection of the alternative avatar appearance as associated with the transition signal from the user; and
storing the transition signal as associated with the alternative avatar appearance in the appearance database.

10. The method of claim 7 wherein the computing device is further for:
receiving a plurality of selections of alternative avatar appearances associated with a plurality of transition signals from the user; and
storing the plurality of transition signals as associated with the plurality of avatar appearances in the appearance database.

11. The method of claim 7 wherein the alternative appearance is associated with a functional aspect of the three-dimensional virtual world or the avatar such that alteration of the appearance causes a numerical change in an aspect of the three-dimensional virtual world or the avatar that changes gameplay or functionality of the avatar within the three-dimensional virtual world.

12. The method of claim 7 wherein:
the alternative appearance is non-functional, but alters an appearance of the avatar within the three-dimensional virtual world;
the alternative appearance is functional and alters the appearance of the avatar within the three-dimensional virtual world; and
the alternative appearance is functional, but does not alter the appearance of the avatar within the three-dimensional virtual world.

13. An apparatus comprising a non-volatile machine-readable medium storing a program having instructions which when executed by a computing device cause the computing device to:
generate a three-dimensional virtual environment including an avatar representing a user within the three-dimensional virtual environment, the avatar having an original avatar appearance;
detect a transition signal within the three-dimensional virtual environment for the avatar;
search an appearance database for an alternative avatar appearance associated with the transition signal;
detect the alternative avatar appearance associated with the transition signal; and
update the avatar to incorporate the alternative avatar appearance to thereby cause the alternative avatar appearance to be present within the three-dimensional virtual environment in association with the avatar, wherein the alternative avatar appearance is selected based upon an attribute of the three-dimensional virtual environment detected within the transition signal.

14. The apparatus of claim 13 wherein the transition signal is triggered by a selected one of:
movement of the avatar from one location with the three-dimensional virtual environment to another location within the three-dimensional virtual environment;
transition from one game mode to another game mode within the three-dimensional virtual environment;
movement of the player from one context within the three-dimensional virtual environment to another context within the three-dimensional virtual environment;
transition from a first three-dimensional virtual environment to a second three-dimensional virtual environment;
transition from the three-dimensional virtual environment to a two-dimensional virtual environment;
initiation of a different mode of play within the three-dimensional environment selected from the group comprising first person shooter combat, a race game, a sports mode, a relaxation mode, a dance mode, a travel mode, a mode associated with the user's self-managed area within the three-dimensional virtual environment, and a lounge mode;
selection of an item or object within the three-dimensional virtual environment;
a load screen associated with transition from a first three-dimensional virtual environment and a second three-dimensional virtual environment;
initialization of the three-dimensional virtual environment in a particular location or to engage in a particular activity; and
transition into operation of a digital vehicle within the three-dimensional virtual environment.

15. The apparatus of claim 13 wherein the computing device is further for:
receiving a selection of the alternative avatar appearance as associated with the transition signal from the user; and
storing the transition signal as associated with the alternative avatar appearance in the appearance database.

16. The apparatus of claim 13 wherein the computing device is further for:
receiving a plurality of selections of alternative avatar appearances associated with a plurality of transition signals from the user; and
storing the plurality of transition signals as associated with the plurality of avatar appearances in the appearance database.

17. The apparatus of claim 13 wherein the alternative appearance is associated with a functional aspect of the three-dimensional virtual world or the avatar such that alteration of the appearance causes a numerical change in an aspect of the three-dimensional virtual world or the avatar that changes gameplay or functionality of the avatar within the three-dimensional virtual world.

18. The apparatus of claim 13 wherein:
the alternative appearance is non-functional, but alters an appearance of the avatar within the three-dimensional virtual world;
the alternative appearance is functional and alters the appearance of the avatar within the three-dimensional virtual world; and
the alternative appearance is functional, but does not alter the appearance of the avatar within the three-dimensional virtual world.

19. The apparatus of claim 13 further comprising:
the processor; and
a memory,
wherein the processor and the memory comprise circuits and software for performing the instructions on the storage medium.

20. The method of claim 1 wherein:
each of the original avatar appearance and the alternative avatar appearance include at least one of an avatar's: skin color, hair color, eye color, outfit, clothing, shoes, items, weapon, craft used, vehicle used, overall shape of face, overall shape of body or functional elements.

21. The method of claim 1 wherein:
each of the original avatar appearance and the alternative avatar appearance include at least one of an avatar's: overall asymmetric shape of face or overall asymmetric shape of body.

22. The method of claim 1 wherein at least one of:
the attribute includes a functional benefit derived from the alternative avatar appearance as compared to the original avatar appearance;
the attribute is caused by one of: a change from one to another context or location, or a flag for a certain location or certain load screen; or
the attribute includes one of a visual or functional aspect of the alternative avatar appearance as compared to the original avatar appearance.
